(19) United States
(12) Patent Application Publication
(10) Pub. No.: US 2013/0257167 A1
(43) Pub. Date: Oct. 3, 2013

(54) APPARATUSES, SYSTEMS, AND METHODS FOR POWER TRANSFER ADJUSTMENT IN WIRELESS POWER TRANSFER SYSTEMS

(71) Applicant: Manjit Singh, Fremont, CA (US)

(72) Inventor: Manjit Singh, Fremont, CA (US)

(73) Assignee: INTEGRATED DEVICE TECHNOLOGY, INC., San Jose, CA (US)

(21) Appl. No.: 13/434,641

(22) Filed: Mar. 29, 2012

(51) Int. Cl. H02J 17/00

(52) U.S. Cl. 307/104

(57) ABSTRACT

A wireless power-transfer system includes a power-transmitting device and a power-receiving device. The power-transmitting device includes, a frequency generator for generating a power-transmit frequency and a transmit coil for generating a near-field electromagnetic radiation responsive to the power-transmit frequency. The power-receiving device, includes a receive resonance circuit that generates a receive resonance frequency and includes a receive coil for receiving the near-field electromagnetic radiation when within a coupling region of the transmit coil and a receive capacitor in combination with the receive coil. The rectifier converts the receive resonance signal to a rectified signal. The signal sensor senses at least one of a voltage or a current on the rectified signal to generate a power indicator signal. The receive impedance adjuster modifies a resonant frequency of the receive resonance circuit responsive to the power indicator signal by selectively modifying an impedance of the receive impedance adjuster.

### TECHNICAL FIELD

Embodiments of the present disclosure relate generally to power transfer and, more particularly, to apparatuses, systems, and methods related to inductive wireless power transfer.

### BACKGROUND

Battery-powered devices (e.g., consumer electronic devices, electric and hybrid automobiles, etc.) are charged from a power source (e.g., AC power outlet) through a charging device. The charging device couples the battery to the power source through an adaptor. The cord extending between the power source and the battery-powered device can take up space. In situations where multiple devices require charging, each with their own charger and cord, the charging area can become cramped and inconvenient.

Approaches are being developed that use over-the-air or wireless power transmission between a transmitter and a receiver coupled to the electronic device. Wireless power transmission using inductive coils is one method considered as an un-tethered method for transferring power wirelessly through a coupled electromagnetic field. In inductive wireless power transmission, power is transferred by transmitting an electromagnetic field through a transmit coil. On the receiver side, a receiver coil may couple with the transmit coil through the electromagnetic field, thus, receiving the transmitted power wirelessly. The distance between the transmitter and receiver coils at which efficient energy transfer can take place, is a function of a coupling coefficient between the coils. The coupling efficiency may be significantly improved if the coils are sized and operated at such a frequency that they are physically within a so-called “near-field zone” (also referred to as a coupling region) of each other.

In resonant topologies used in inductive wireless power transfer systems, the conversion gain from the input of the transmitter to an un-regulated rectified output of the receiver can become very high under some operating conditions. This operating condition may result in a very high output voltage on the rectified output of the receiver. High output voltage on the rectified output signal can damage downstream circuits such as Direct Current (DC) to DC converters, batteries, chargers, and similar circuits coupled to the rectified output.

### BRIEF SUMMARY

Embodiments of the present disclosure include methods and apparatuses to regulate output power on a power-receiving device by adjusting a resonant frequency of the power-receiving device, which modifies a resonance match between a transmit coil and a receive coil, which modifies a perceived input impedance of a transmit resonance circuit. The modified resonant frequency of the transmit resonance circuit modifies transmitted power on the transmit coil.

Embodiments of the present disclosure include a power-receiving device including a receive resonance circuit configured to generate a receive resonance frequency, a rectifier, a signal sensor, and a receive impedance adjuster. A receive coil of the receive resonance circuit is for receiving near-field electromagnetic radiation at a coupling frequency when within a coupling region of a transmit coil. A receive capacitor of the receive resonance circuit is operably coupled to the receive coil and is configured to operate in combination with the receive coil to generate a receive resonance signal at the receive resonance frequency when the receive coil is stimulated by the near-field electromagnetic radiation. The rectifier is operably coupled to the receive resonance signal and is configured to convert the receive resonance signal to a rectified signal at a substantially Direct Current (DC) level. The signal sensor is operably coupled to the rectified signal and is configured to sense at least one of a voltage on the rectified signal or a current on the rectified signal to generate a power indicator signal. The receive impedance adjuster is operably and selectively coupled to the receive resonance circuit and is configured to adjust a resonant frequency of the receive resonance circuit responsive to the power indicator signal by selectively modifying an impedance of the receive impedance adjuster.

Embodiments of the present disclosure also include a method of receiving power, including stimulating a receive resonance circuit including a receive coil and a receive capacitor to generate a receive resonance signal at a receive resonance frequency by positioning the receive coil in a coupling region of a transmit coil generating a near-field electromagnetic radiation at a coupling frequency. The receive resonance signal is rectified to a rectified signal at substantially a DC level. At least one of a voltage on the rectified signal or a current on the rectified signal is sensed to generate a power indicator signal. A resonant frequency of the receive resonance circuit is adjusted responsive to the power indicator signal by selectively modifying an impedance of a receive impedance adjuster operably coupled to the receive resonance circuit.

Embodiments of the present disclosure further include a wireless power-transfer system including a power-transmitting device and a power-receiving device. The power-transmitting device includes, a frequency generator for generating a power-transmit frequency and a transmit coil for generating a near-field electromagnetic radiation at a transmit resonance frequency responsive to the power-transmit frequency. The power-receiving device, includes a receive resonance circuit, a rectifier, a signal sensor, and a receive impedance adjuster. The receive resonance circuit is configured to generate a receive resonance frequency and includes a receive coil for receiving the near-field electromagnetic radiation at a coupling frequency when within a coupling region of the transmit coil. A receive capacitor of the receive resonance circuit is operably coupled to the receive coil and is configured to operate in combination with the receive coil to generate a receive resonance signal at the receive resonance frequency when the receive coil is stimulated by the near-field electromagnetic radiation. The rectifier is operably coupled to the receive resonance signal and is configured to convert the receive resonance signal to a rectified signal substantially at a DC level. The signal sensor is operably coupled to the rectified signal and is configured to sense at least one of a voltage on the rectified signal or a current on the rectified signal to generate a power indicator signal. The receive impedance adjuster is operably and selectively coupled to the receive resonance circuit and is configured to adjust a resonant frequency of the receive resonance circuit responsive to the power indicator signal by selectively modifying an impedance of the receive impedance adjuster.

### BRIEF DESCRIPTION OF THE SEVERAL VIEWS OF THE DRAWINGS

FIG. 1 is a block diagram of an inductive wireless power-transfer system;

FIG. 2 is a detailed block diagram on an inductive wireless power-transfer system according to one or more embodiments of the present disclosure;

FIG. 3 is a schematic diagram of a small signal equivalent model showing inductive and capacitive elements that may be present when a wireless power transmitter and a wireless power receiver are coupled;

FIGS. 4A-4C are circuit diagrams of example impedance adjusters that may be used in the wireless power receiver according to one or more embodiments of the present disclosure;

FIG. 5 is a graph of a small-signal representation of input impedance of a wireless power transmitter wirelessly coupled to a wireless power receiver before and after modifying an impedance of the wireless power receiver according to one or more embodiments of the present disclosure;

FIG. 6 is a graph of voltage output of a rectified signal on a power-receiving device and current input to a transmit resonance circuit on a power-transmitting device according to one or more embodiments of the present disclosure;

FIG. 7 is a flow chart illustrating a method for inductive wireless power transfer according to an embodiment of the present disclosure.

### DETAILED DESCRIPTION

In the following description, reference is made to the accompanying drawings in which is shown, by way of illustration, specific embodiments of the present disclosure. The embodiments are intended to describe aspects of the disclosure in sufficient detail to enable those skilled in the art to practice the invention. Other embodiments may be utilized and changes may be made without departing from the scope of the disclosure. The following detailed description is not to be taken in a limiting sense, and the scope of the present invention is defined only by the appended claims.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor is configured to execute instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

In addition, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer readable media. Computer-readable media includes both computer storage media and communication media, including any medium that facilitates transfer of a computer program from one place to another.

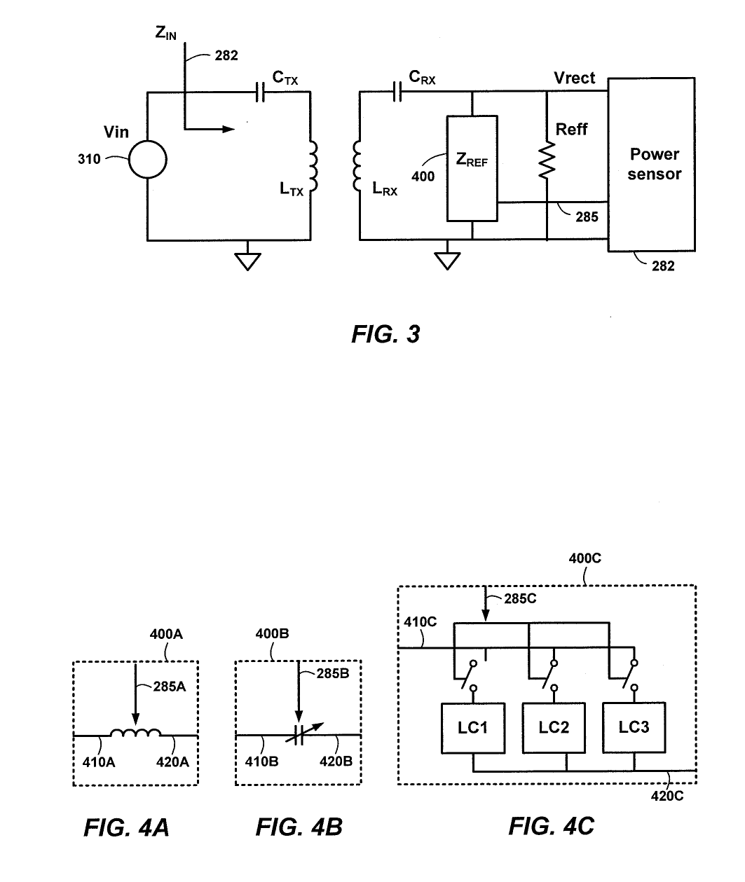

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. For example, where feasible elements in FIG. 3 are designated with a format of 3xx, where 3 indicates FIG. 3 and xx designates the unique element.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. In addition, unless stated otherwise, a set of elements may comprise one or more elements.

The words “wireless power” are used herein to mean any form of energy associated with electric fields, magnetic fields, electromagnetic fields, or otherwise that is transmitted from a transmitter to a receiver without the use of physical electromagnetic conductors.

Embodiments of the present disclosure include methods and apparatuses to regulate output power on a power-receiving device by adjusting a resonant frequency of the power-receiving device, which modifies a resonance match between a transmit coil and a receive coil, which modifies a perceived input impedance of a transmit resonance circuit. The modified resonant frequency of the transmit resonance circuit modifies transmitted power on the transmit coil.

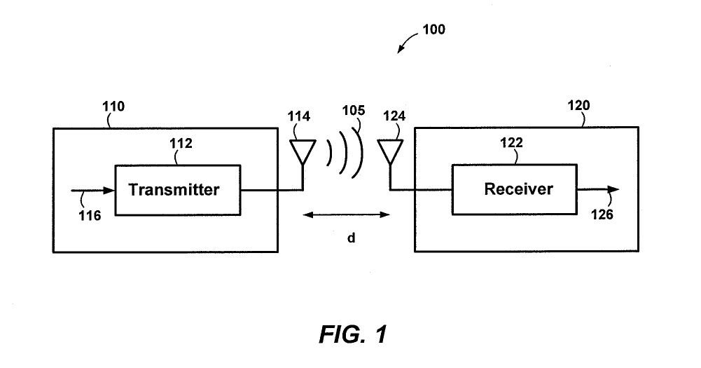

FIG. 1 is a block diagram of an inductive wireless power-transfer system 100. The inductive wireless power-transfer system 100 includes a power-transmitting device 110, and a power-receiving device 120. The power-transmitting device 110 includes a transmitter 112 coupled with a transmit coil 114 configured to generate an electromagnetic field 105 for providing energy transfer to the power-receiving device 120. The power-receiving device 120 includes a receiver 122 coupled with a receive coil 124 configured to couple with the electromagnetic field 105. The transmit coil 114 and the receive coil 124 may be sized according to the particular devices and applications to be associated therewith.

An input power signal 116 is provided to the transmitter 112 for providing the transmitter 112 with the power for generating the electromagnetic field 105, which provides energy transfer to the power-receiving device 120. The receiver 122 couples to the electromagnetic field 105 and generates an output power 126 in response thereto. The output power signal 126 may provide the power that is used by the power-receiving device 120 for storing (e.g., charging a battery or capacitance), consumption (e.g., providing system power), or both.

The transmit coil 114 and the receive coil 124 are separated by a distance (d). In some embodiments, the transmitter 112 and the receiver 122 may be configured according to a mutual inductance relationship, such that when the resonant frequency of the receiver 122 and the resonant frequency of the transmitter 112 are substantially the same, transmission losses between the transmitter 112 and the receiver 122 are minimal. In other words, an efficient energy transfer occurs by coupling a large portion of the energy in a near field of the transmit coil 114 to the receive coil 124 rather than propagating most of the energy in an electromagnetic wave to the far field. If the power-receiving device 120 is in the near field, a coupling mode for the near-field electromagnetic radiation may be developed between the transmit coil 114 and the receive coil 124. The area around the transmit coil 114 and receive coil 124 where this near-field coupling may occur may be referred to as a coupling region.

As non-limiting examples, the power-receiving device 120 may be a mobile electronic device such as a cell phone, smart phone, media player (e.g., mp3 player), electronic reader, tablet, personal digital assistant (PDA), camera, lap top computer, and personal electronic device in which wireless power may be received. As other non-limiting examples, the power-receiving device 120 may also be a less mobile electronic device, such as a television, personal computer, media player (e.g., DVD player, Blu-ray player, etc.) or any other device that may run from, or store electrical power. For even more non-limiting examples, the power-receiving device 120 may be one of a number of other items, such as an automobile or any other devices that may include batteries that may be charged through the power-transmitting device 110.

The power-transmitting device 110 (may also be referred to herein as a base station) may include a number of structures, device, or combinations thereof bearing the transmit coil 114. As non-limiting examples, the wireless power-transmitting device 110 may include furniture, floors, walls, ceilings, and vehicles bearing a transmit coil 114 positioned such that a power-receiving device 120 may be disposed within the coupling region of the transmit coil 114. As other non-limiting examples, wireless the power-transmitting device 110 may include electronic devices such as, televisions, personal computers, media players (e.g., radio, DVD player, Blu-ray player, etc.) or any other device for which in may be useful to provide wireless power transfer to a power-receiving device 120.

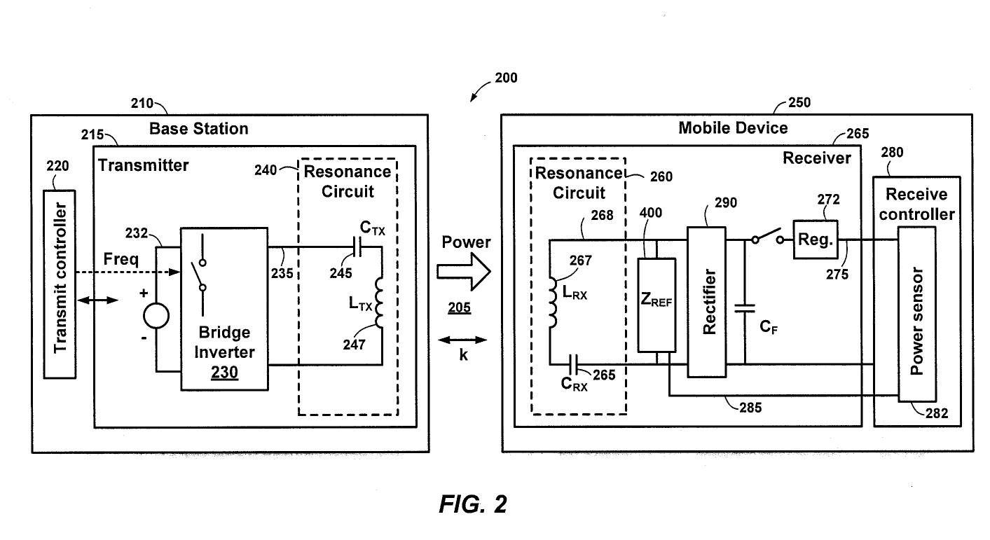

FIG. 2 is a detailed block diagram on an inductive wireless power-transfer system 200 according to one or more embodiments of the present disclosure. A base station 210 (e.g., the power-transmitting device 110 of FIG. 1) may inductively transmit power to a mobile device 250 (.e.g., the power-receiving device 120 of FIG. 1) using near-field electromagnetic radiation in a coupling region 205.

The base station 210 may include a transmit controller 220 and a wireless power transmitter 215. The wireless power transmitter 215 may include a bridge inverter 230 (may also be referred to herein as a frequency generator) and a transmit resonance circuit 240. The bridge inverter 230 is coupled to a Direct Current (DC) power source (power input 232) and is controlled by a frequency control signal (indicated with a dashed line) from the transmit controller 220. The bridge inverter 230 may be any suitable circuit for converting a DC power source to an Alternating Current (AC) signal at a desired frequency responsive to the frequency control signal. As non-limiting examples, the bridge inverter 230 may be a half-bridge inverter or a full-bridge inverter. Moreover, other types of frequency generators suitable for providing the power and frequency needed to drive the transmit resonance circuit 240 may be used. The output of the bridge inverter 230 is a power-transmit frequency 235, which may, in some embodiments, be filtered, smoothed, or a combination thereof, before driving the transmit resonance circuit 240.

The transmit resonance circuit 240 is coupled to the power-transmit frequency 235 and includes a transmit coil 247 (L_{TX}) coupled to a transmit capacitor 245 (C_{TX}). The transmit resonance circuit 240 is configured to develop a coupling frequency (may also be referred to herein as a transmit resonance frequency) determined by impedances of the transmit coil 247 and the transmit capacitor 245.

The transmit controller 220 may include a processor (e.g., microprocessor) and other peripherals (e.g., memory). Memory may include non-volatile memory (e.g., ROM) and volatile memory (e.g., RAM). In some embodiment, the transmit controller 220 may sample signals such as the power-transmit frequency 235 and the transmit resonance frequency. Analysis of these frequencies may be used to form a control loop to adjust the power-transmit frequency 235.

As a non-limiting example, the control loops may include a linear feedback control system, such as, for example, a proportional integral derivative controller. Of course, other feedback/control topologies may also be used.

The mobile device 250 may include a receive controller 280 and a wireless power receiver 255. The wireless power receiver 255 may include a receive resonance circuit 260, a rectifier 290, a filter, and a regulator 272. The filter is illustrated as a capacitor C_{F}. However, the filter may be more complex including other components such as capacitors, inductors, resistors, and active components for controlling characteristics of the filter.

The receive resonance circuit 260 may be inductively coupled with the transmit resonance circuit 240 such that power at an inductive coupling factor (k) is transferred therebetween. The receive resonance circuit 260 includes a receive coil 267 (L_{RX}) coupled to a receive capacitor 265 (C_{RX}). The receive resonance circuit 260 is configured to develop a receive resonance signal 268 at a receive resonance frequency determined by impedances of the receive coil 267 and the receive capacitor 265.

A receive impedance adjuster 400 (denoted as Z_{REF} in FIG. 2) is coupled to the receive resonance circuit 260 and is configured to adjust the impedance of the wireless power receiver 255 as is explained more fully below in connection with FIG. 4.

In some embodiments, the rectifier 290 may be used to convert the receive resonance signal 268 to substantially a DC signal. The filter and regulator 272 may be used in some embodiments to further smooth the DC signal and set it to an appropriate DC voltage as a rectified signal 275 (may also be referred to herein as V_{RECT} or a power output 275) for use by the receive controller 280.

The receive controller 280 includes a signal sensor 282 configured to sense at least one of a voltage or a current on the rectified signal 275 to generate a power indicator signal 285.

The receive controller 280 may include a processor (e.g., microprocessor) and other peripherals (e.g., memory). Memory may include non-volatile memory (e.g., ROM) and volatile memory (e.g., RAM). In some embodiment, the receive controller 280 may sample signals such as the rectified signal 275. Analysis of the rectified signal 275 may be used to form a control loop to adjust the impedance of the receive impedance adjuster 400 via the receive resonance control signal 295. As a non-limiting example, the control loops may include a linear feedback control system, such as, for example, a proportional integral derivative controller. Of course, other feedback/control topologies may also be used. In some embodiments, the signal sensor 282 may more directly control the feedback loop to the power indicator signal 285 with no need for sampling or detailed analysis by a microcontroller within the receive controller 280.

The receive controller 280 may generally include a load, which may generally include a battery for charging from the rectified signal 275, the circuitry of the receive controller 280, or a combination thereof.

The transmit coil 247 and the receive coil 267 may be considered like antennas that may be configured as a “loop” antenna, which may also be referred to herein as a “magnetic” antenna or an “inductive” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive coil 267 within a plane of the transmit coil 247 where the coupling region 205 of the transmit coil 247 may be more powerful.

As stated, efficient transfer of energy between the wireless power transmitter 215 and wireless power receiver 255 may occur during matched or nearly matched resonance between the transmit resonance circuit 240 and the receive resonance circuit 260. However, even when the resonances are not matched, energy may still be transferred, but at a somewhat lower efficiency. Transfer of energy occurs by coupling energy from the near field of the transmit coil 247 to the receive coil 267 residing in the neighborhood where this near field is established rather than propagating the energy from the transmit coil 247 into free space.

The resonant frequency of the loop or magnetic antennas is based primarily on the inductance and capacitance. Inductance in a loop antenna is generally simply the inductance created by the loop, whereas, capacitance is generally added to the loop antenna's inductance to create a resonant structure at a desired resonant frequency.

In some wireless power systems, the mobile device 250 may signal to the base station 210 a desired power level. Other systems may not include such a signaling capability or the signaling capability is not operating correctly. In such conditions, the conversion gain from the input of the transmitter to an un-regulated rectified signal 275 of the mobile device 250 can become very high under some operating conditions. This operating condition may result in a very high output voltage on the rectified signal 275. High output voltage on the rectified signal 275 can damage downstream circuits on the mobile device 250 such as DC to DC converters, batteries, chargers, and similar circuits coupled to the rectified signal 275.

In such systems where the transmit power cannot be regulated through communication between the mobile device 250 and the base station 210, embodiments of the present disclosure include a feedback mechanism within the mobile device 250 to essentially throttle the power output of the base station 210 to a power level that is acceptable for the mobile device 250.

FIG. 3 is a schematic diagram of a small signal equivalent model showing inductive and capacitive elements that may be present when a wireless power transmitter and a wireless power receiver are coupled. FIG. 3 is an alternate representation of the wireless power-transfer system 200 of FIG. 2. The capacitor C_{TX} represents capacitance of the transmit capacitor 245 and the capacitor C_{RX} represents capacitance of the receive capacitor 265. The circuit is stimulated by an AC signal (V_{IN}) (e.g., the power-transmit frequency 235 of FIG. 2). The resistor R_{EFF} is a simplified model of the load from the filter, regulator 272, and receive controller 280 of FIG. 2.

Referring to FIGS. 2 and 3, the resonant frequencies of the transmit resonance circuit 240 and the receive resonance circuit 260 may be separately adjusted. Resonances may be adjusted such that the resonant frequencies between the transmit side and the receive side are very close to optimize power transfer. However, in embodiments of the present disclosure, resonance of the receive resonance circuit 260 may be modified by modifying the impedance of the receive impedance adjuster 400 to create a frequency mismatch between the transmit resonance circuit 240 and the receive resonance circuit 260. This frequency mismatch creates a change in perceived input impedance Z_{IN} into the transmit resonance circuit 240. Stated another way, impedance of the receive resonance circuit 260 gets reflected over to the transmit resonance circuit 240, which is manifest as a change in input impedance Z_{IN}.

Adjustments to the impedance of the receive impedance adjuster 400 cause changes to the resonant frequency of the receive resonance circuit 260, responsive to the power indicator signal 285 coupled to the power sensor 282 as discussed above.

FIGS. 4A-4C are circuit diagrams of example receive impedance adjusters 400 that may be used in the wireless power receiver 255 (FIG. 2) according to one or more embodiments of the present disclosure. Reference will be made to FIGS. 2 and 4A-4C to describe the receive impedance adjusters 400. FIGS. 4A-4C illustrate examples of some receive impedance adjusters 400A-400C. Of course, many other configuration of receive impedance adjusters 400 are possible and may include capacitive, inductive, resistive, and active components.

In a non-limiting simple form illustrated in FIG. 4A, the receive impedance adjuster 400A may be a simple variable inductor between terminal 410A and terminal 420A. In this form, the variable inductor may be set responsive to the power indicator signal 285A to modify the resonant frequency of the receive resonance circuit 260 as explained more fully below.

In another non-limiting form illustrated in FIG. 4B, the receive impedance adjuster 400B may be a simple variable capacitor between terminal 410B and terminal 420B. In this form, the variable capacitor may be set responsive to the power indicator signal 285B to modify the resonant frequency of the receive resonance circuit 260 as explained more fully below.

In another non-limiting form illustrated in FIG. 4C, the receive impedance adjuster 400C may be a network between terminal 410C and terminal 420C that is controlled by the power indicator signal 285C. In this form, the network may include active components configured as switches to selectively switch a corresponding LC circuits (LC1, LC2, and LC3) in to the network to create a variable impedance for the receive impedance adjuster 400C. As a non-limiting example, the switches may be configured as transistors, such as Metal Oxide Semiconductor (MOS) transistors. The LC circuits (LC1, LC2, and LC3) may be combinations of inductors, capacitors, or both to create a variety of different impedances that can be selectively switched in to the network.

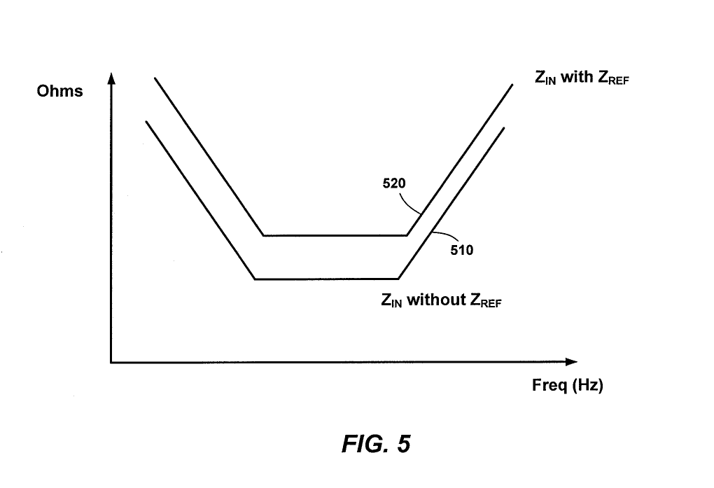

FIG. 5 is a graph of a small-signal representation of input impedance of a wireless power transmitter 215 wirelessly coupled to a wireless power receiver 255 before and after modifying an impedance of the wireless power receiver 255 according to one or more embodiments of the present disclosure. With closely matched resonant frequencies between the transmit resonance circuit 240 and the receive resonance circuit 260, the impedance (ZIN) seen by the transmit resonance circuit 240 may appear like line 510. If the resonant frequency of the receive resonance circuit 260 is modified by modifying the impedance of the receive impedance adjuster 400, the impedance (ZIN) seen by the transmit resonance circuit 240 may be larger and appear like line 520. This larger impedance will result in less power being emitted by the transmit resonance circuit 240, which will result in less power being received by the receive resonance circuit 260.

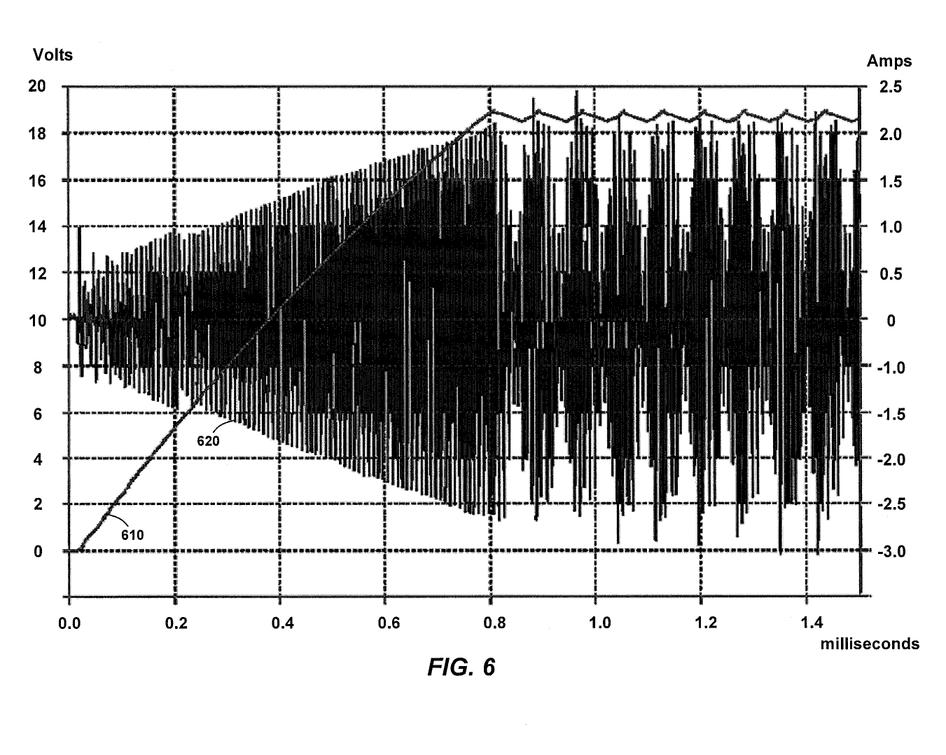

FIG. 6 is a graph of voltage output 610 of the rectified signal 275 on a mobile device 250 and current input 620 to a transmit resonance circuit 240 on a base station 210 according to one or more embodiments of the present disclosure. As illustrated by the voltage output 610, the voltage increases until a desired level of about 18.5 volts is reached. This rise in the voltage output 610 is in response to the rise in peak-to-peak current on the current input 620 from zero to about 4 volts peak to peak (i.e., about −2 volts to about 2 volts).

With reference to FIGS. 2 and 6, when the voltage output 610 reaches about 19 volts, the power indicator signal 285 modifies the impedance of the receive impedance adjuster 400, which causes a change to the resonant frequency of the receive resonance circuit 260. This change in resonant frequency of the receive resonance circuit 260 causes an input impedance change to the transmit resonance circuit 240, which causes the peak-to-peak current on the current input 620 to drop to about 2 volts.

When the voltage output 610 reaches about 18 volts, the power indicator signal 285 modifies the impedance of the receive impedance adjuster 400, which causes a change to the resonant frequency of the receive resonance circuit 260. This change in resonant frequency of the receive resonance circuit 260 causes an input impedance change to the transmit resonance circuit 240, which causes the peak-to-peak current on the current input 620 to rise to about 4 volts. This cycle is repeated in a feedback loop that keeps the voltage output 610 within a tolerance range of about 18 to 19 volts. Of course, FIG. 6 is one example. Other voltages on the voltage output 610 and currents on the current input 620 may be used, depending on system considerations.

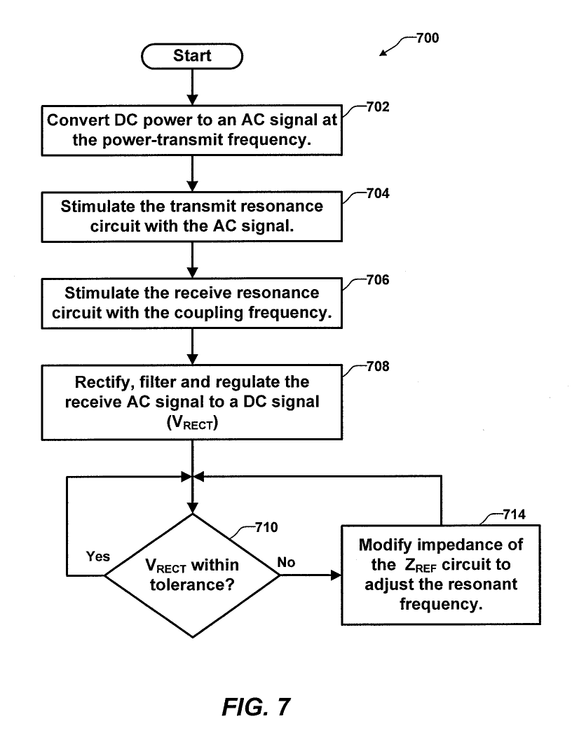

FIG. 7 is a flow chart illustrating a method 700 for inductive wireless power transfer according to an embodiment of the present disclosure. Reference will also be made to FIG. 2 in describing the operations of FIG. 7. Operation block 702 indicates that the system may convert DC power to AC power at the power-transmit frequency 235. For various combinations of the base station 210 and the mobile device 250, this frequency may be modified during operation. Operation block 704 indicates that the transmit resonance circuit 240 is stimulated by the power-transmit frequency 235. Operation block 706 indicates that the receive resonance circuit 260 is stimulated by inductive coupling from the transmit resonance circuit 240 resonating at the coupling frequency to the receive resonance circuit 260.

Operation block 708 indicates that the receive resonance signal 268 is rectified, filtered, regulated, or combinations thereof to generate the rectified signal 275.

Decision block 710 indicates that the rectified signal 275 is sensed and checked to see if it is within a desired tolerance level. If so, the process loops to test the rectified signal 275 repeatedly.

If the rectified signal 275 is not within tolerance, operation block 714 indicates that the impedance of the receive impedance adjuster 400 (i.e. Z_{REF}) is adjusted to modify the resonant frequency of the receive resonance circuit 260. The process then loops to decision block 710 to test whether the rectified signal 275 is within a desired tolerance levels.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A power-receiving device, comprising:
a receive resonance circuit configured to generate a receive resonance frequency, comprising:
a receive coil for receiving near-field electromagnetic radiation at a coupling frequency when within a coupling region of a transmit coil; and
a receive capacitor operably coupled to the receive coil and configured to operate in combination with the receive coil to generate a receive resonance signal at the receive resonance frequency when the receive coil is stimulated by the near-field electromagnetic radiation;
a rectifier operably coupled to the receive resonance signal and configured to convert the receive resonance signal to a rectified signal at a substantially Direct Current (DC) level;
a signal sensor operably coupled to the rectified signal and configured to sense at least one of a voltage or a current on the rectified signal to generate a power indicator signal; and
a receive impedance adjuster operably and selectively coupled to the receive resonance circuit and configured to adjust a resonant frequency of the receive resonance circuit responsive to the power indicator signal by selectively modifying an impedance of the receive impedance adjuster.

2. The power-receiving device of claim 1, wherein the receive impedance adjuster comprises a variable capacitance and the variable capacitance is configured to be selectively adjusted responsive to the power indicator signal.

3. The power-receiving device of claim 1, wherein the receive impedance adjuster comprises a variable inductance and the variable inductance is configured to be selectively adjusted responsive to the power indicator signal.

4. The power-receiving device of claim 1, wherein the receive impedance adjuster comprises:
a variable capacitance; and
a variable inductance;
wherein the resonant frequency is configured to be selectively adjusted by adjusting at least one of the variable capacitance and the variable inductance.

5. The power-receiving device of claim 1, wherein the receive impedance adjuster comprises a network comprising first components to generate at least a capacitive portion of the receive impedance adjuster.

6. The power-receiving device of claim 5, wherein the first components comprise at least one first active component configured as a switch operably coupled to include at least one corresponding capacitor.

7. The power-receiving device of claim 5, wherein the network further comprises second components including at least one second active component configured as a switch operably coupled to include at least one corresponding inductor.

8. The power-receiving device of claim 1, further comprising a receive controller configured to control the power indicator signal responsive to an analysis of at least one of a sampled voltage on the rectified signal and a sampled current on the rectified signal.

9. A method of receiving power, comprising:
stimulating a receive resonance circuit including a receive coil and a receive capacitor to generate a receive resonance signal at a receive resonance frequency by positioning the receive coil in a coupling region of a transmit coil generating a near-field electromagnetic radiation at a coupling frequency;
rectifying the receive resonance signal to a rectified signal at substantially a DC level;
sensing at least one of a voltage or a current on the rectified signal to generate a power indicator signal; and
adjusting a resonant frequency of the receive resonance circuit responsive to the power indicator signal by selectively modifying an impedance of a receive impedance adjuster operably coupled to the receive resonance circuit.

10. The method of claim 9, further comprising adjusting at least a capacitive portion of the receive impedance adjuster to adjust the receive resonance frequency.

11. The method of claim 10, wherein adjusting at least the capacitive portion comprises selectively and operably coupling one or more capacitors to the receive resonance circuit.

12. The method of claim 9, further comprising adjusting at least an inductive portion of the receive impedance adjuster to adjust the receive resonance frequency.

13. The method of claim 12, wherein adjusting at least the inductive portion comprises selectively and operably coupling one or more inductors to the receive resonance circuit.

14. The method of claim 9, further comprising:
sampling at least one of a voltage and a current on the rectified signal; and
performing an analysis to determine the power indicator signal responsive to the sampled voltage, the sampled current, or a combination thereof.

15. A wireless power-transfer system, comprising:
a power-transmitting device, comprising:
a frequency generator for generating a power-transmit frequency; and
a transmit coil for generating a near-field electromagnetic radiation at a transmit resonance frequency responsive to the power-transmit frequency; and
a power-receiving device, comprising:
a receive resonance circuit configured to generate a receive resonance frequency, comprising:
a receive coil for receiving the near-field electromagnetic radiation at a coupling frequency when within a coupling region of the transmit coil; and
a receive capacitor operably coupled to the receive coil and configured to operate in combination with the receive coil to generate a receive resonance signal at the receive resonance frequency when the receive coil is stimulated by the near-field electromagnetic radiation;
a rectifier operably coupled to the receive resonance signal and configured to convert the receive resonance signal to a rectified signal at substantially a DC level;
a signal sensor operably coupled to the rectified signal and configured to sense at least one of a voltage or a current on the rectified signal to generate a power indicator signal; and
a receive impedance adjuster operably and selectively coupled to the receive resonance circuit and configured to adjust a resonant frequency of the receive resonance circuit responsive to the power indicator signal by selectively modifying an impedance of the receive impedance adjuster.

16. The wireless power-transfer system of claim 15, wherein the receive impedance adjuster comprises a variable capacitance and the variable capacitance is configured to be selectively adjusted responsive to the power indicator signal.

17. The wireless power-transfer system of claim 15, wherein the receive impedance adjuster comprises a variable inductance and the variable inductance is configured to be selectively adjusted responsive to the power indicator signal.

18. The wireless power-transfer system of claim 15, wherein the receive impedance adjuster comprises:
a variable capacitance; and
a variable inductance;
wherein the resonant frequency is configured to be selectively adjusted by adjusting at least one of the variable capacitance and the variable inductance.

19. The wireless power-transfer system of claim 15, wherein the receive impedance adjuster comprises a network comprising first components to generate at least a capacitive portion of the receive impedance adjuster.

20. The wireless power-transfer system of claim 19, wherein the first components comprise at least one first active component configured as a switch operably coupled to include at least one corresponding capacitor.

21. The wireless power-transfer system of claim 19, wherein the network further comprises second components including at least one second active component configured as a switch operably coupled to include at least one corresponding inductor.

22. The wireless power-transfer system of claim 15, further comprising a receive controller configured to control the power indicator signal responsive to an analysis of at least one of a sampled voltage on the rectified signal and a sampled current on the rectified signal.
